(19) United States
(12) Patent Application Publication
(10) Pub. No.: US 2016/0087571 A1
(43) Pub. Date: Mar. 24, 2016

(54) CIRCUIT ARRANGEMENT HAVING REDUNDANT HALF BRIDGES FOR OPERATING AN ELECTRIC MACHINE

(71) Applicant: Continental Automotive GmbH, Hannover (DE)

(72) Inventors: Reinhold Berberich, Frankfurt (DE); Jörg Dammköhler, Schmitten/Oberreifenberg (DE); Michael Henninger, Kelkheim (DE)

(73) Assignee: Continental Automotive GmbH, Hannover (DE)

(21) Appl. No.: 14/888,723

(22) PCT Filed: Apr. 15, 2014
(86) PCT No.: PCT/EP2014/057669

§ 371 Date: Nov. 3, 2015

(30) Foreign Application Priority Data
May 8, 2013 (DE) 10 2013 208 569.9

(51) Int. Cl. H02P 25/22

(52) U.S. Cl. CPC H02P 25/22

(57) ABSTRACT

A circuit arrangement for operating an electric machine, which has a plurality of lines, each for one phase of an alternating current to the electric machine, each line having a plurality of series-connected switching elements that form a half bridge, the half bridge having a terminal between two switching elements, and the circuit arrangement being electrically couplable to the electric machine via the terminals of the half bridge. The circuit arrangement is characterized in that each line has a plurality of half bridges, which are electrically connected parallel to each other.

### CROSS REFERENCE TO RELATED APPLICATIONS

This application is the U.S. National Phase Application of PCT International Application No. PCT/EP2014/057669, filed Apr. 15, 2014, which claims priority to German Patent Application No. 10 2013 208 569.9, filed May 8, 2013, the contents of such applications being incorporated by reference herein.

### FIELD OF THE INVENTION

The invention relates to a circuit arrangement for operating an electric machine, and to a power steering system for a motor vehicle having a circuit arrangement.

### BACKGROUND OF THE INVENTION

Power steering systems in motor vehicles have the function of assisting the driver's steering movements. The steering constitutes here a basic function of a motor vehicle, which has to be ensured at all times during driving. For safety reasons it is therefore necessary for the power steering system to be configured as far as possible in a failsafe fashion and to permit the vehicle to be steered even in the event of a defect. However, in the event of a defect in the control electronics or in the electric motor there is the risk that the engine will act as a generator as a result of the driver's steering movement and apply a torque counter to the steering movement instead of an assisting torque. A failure not only results in a failure of the steering assistance, but can also counteract the steering.

A cause of the failure of an electric machine can be, inter alia, that the control electronics can no longer correctly actuate the electric machine owing to the mechanical or electrical loads. Therefore, there is also frequently an occurrence of the fault according to which the control electronics are damaged owing to high thermal loads.

It is known to provide the electric machines in power steering systems with mechanical or electronic star point relays in order to interrupt the circuit of the electric machine in the event of a defect and in this way prevent an action by the electric machine which impedes the steering movement.

It is known, according to DE 10 19 736, which is incorporated by reference, to install a safety circuit for electronically commutated motors in the power steering system, which safety circuit prevents current from flowing through the windings of the motor in the event of a fault. The motor is therefore disconnected from the circuit and does not bring about a torque which impedes or even blocks the steering movement.

In both cases, the steering assistance is eliminated entirely, with the result that steering of the motor vehicle can be carried out only with a large expenditure of force.

### SUMMARY OF THE INVENTION

An aspect of the invention is a circuit arrangement for operating an electric machine which is as failsafe as possible.

This is achieved by means of a circuit arrangement of the type mentioned at the beginning with lines which each have a plurality of half bridges which are connected electrically in parallel with one another.

An aspect of the invention is based on the basic concept of increasing the reliability of the circuit arrangement by means of redundancy of half bridges. The power supply through a line can be maintained in this way even if one half bridge in a line fails. The redundancy can be implemented here in a particularly simple and cost-effective way through the parallel connection of a plurality of half bridges within one line. In particular, in this way an electric machine which is divided into a plurality of drive units can be operated by means of a single circuit arrangement, which substantially reduces the costs and the installation space for the control of the electric machine.

The circuit arrangement according to an aspect of the invention in which the electric machine has a plurality of winding phases which are connected to form star circuits is advantageously developed, wherein the half bridges of one line are each to be assigned to different star circuits. The winding phases can comprise a plurality of winding units which are fed with a phase current. Each winding phase can in this way be actuated separately by means of a separate half bridge and supplied with current. A failure of a half bridge or of a winding unit does not have any direct effect on the rest of the half bridges or winding units and permits particularly safe implementation of the control of the electric machine with a star circuit. Additional deactivation mechanisms which have been necessary hitherto according to the prior art, such as safety relays or phase switches, can be dispensed with.

Likewise, an embodiment of the circuit arrangement according to an aspect of the invention is advantageous in which the electric machine has a plurality of winding phases which are connected to form delta circuits, wherein the half bridges of one line are each to be assigned to different delta circuits. The embodiment permits particularly safe control of an electric machine with a delta circuit by means of the circuit arrangement according to the invention.

In addition, an embodiment of the circuit arrangement according to an aspect of the invention is preferred in which the switching elements have transistors, and wherein the maximum operating current of the transistor is lower than the maximum operating current of the electric machine. In this way, more cost-effective and smaller transistors can be used for the half bridges. The transistors which are used in this embodiment generally have a lower overall space requirement than individual transistors which are configured for the maximum operating current. The installation space on a circuit board, for example, can as a result be used more efficiently.

In addition, an embodiment of the circuit arrangement according to an aspect of the invention is preferred which has conductors for conducting the current, wherein the cross section of the conductors between the switching elements of the half bridge and/or the connection of a half bridge and the electric machine is smaller than the cross section of a conductor for conducting the maximum operating current of the electric machine. The redundancy of the half bridges and of the conductors can in this way be used to configure the switching elements and the conductors for low current loads and as a result save costs and installation space.

Furthermore, an embodiment of the circuit arrangement according to an aspect of the invention has proven advantageous in which the line has two half bridges which are connected in parallel with one another. The limitation of the redundancy to two half bridges per line has proven a particularly cost-effective embodiment of the circuit arrangement with reliability which is sufficient for use in practice.

An aspect of the invention also relates to a power steering system for a motor vehicle having a circuit arrangement as in one of the preceding embodiments.

### BRIEF DESCRIPTION OF THE DRAWINGS

Further preferred embodiments arise from the following description of an exemplary embodiment with reference to figures. In each case identical elements are provided in the subsequent figures only with one reference symbol, for the sake of simplicity. In the drawings:

FIG. 1 shows a schematic illustration of a first exemplary embodiment of the circuit arrangement according to the invention, and

FIG. 2 shows a schematic illustration of a second exemplary embodiment of the circuit arrangement according to the invention.

### DETAILED DESCRIPTION OF THE PREFERRED EMBODIMENTS

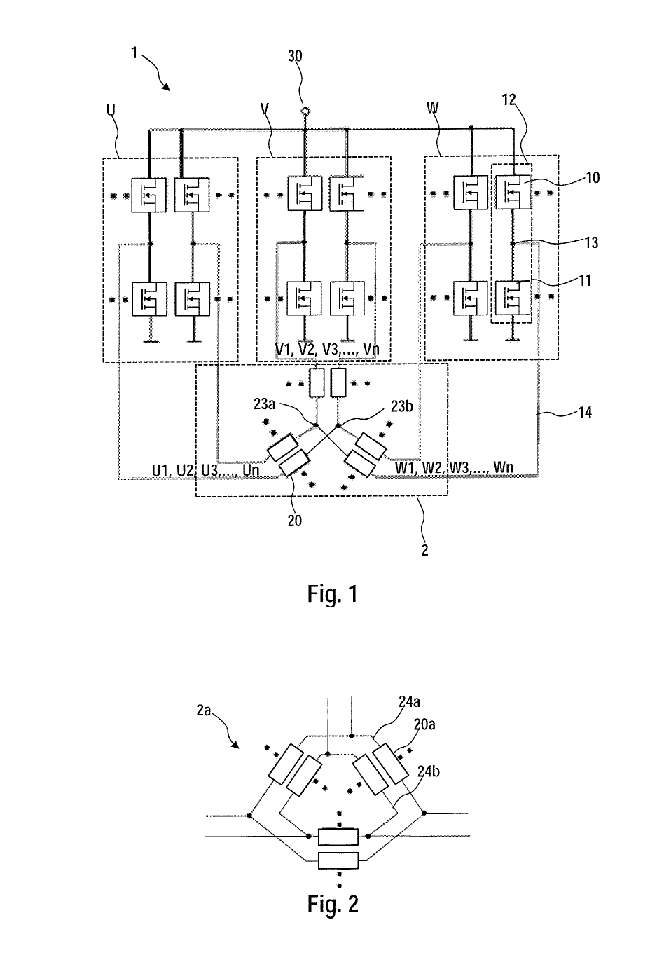

FIG. 1 shows a circuit arrangement 1 for operating an electric machine 2, which circuit arrangement 1 has a plurality of lines U, V, W for feeding current to the electric machine 2. Each line U, V, W has a plurality of switching elements 10, 11 which are connected in series and which form a half bridge 12. Between the two switching elements 10, 11, the half bridge 12 has a connection 13 via which the circuit arrangement 1 can be electrically coupled to the electric machine 2. Each line U, V, W has a plurality of half bridges 12 which are connected electrically in parallel with one another.

In the first exemplary embodiment according to FIG. 1, the electric machine 2 has a plurality of winding phases 20 which are connected in a star circuit 23a, 23b. The half bridges 12 of a line U, V, W are each assigned to a winding phase 20 of the star circuits 23a, 23b.

In the second exemplary embodiment according to FIG. 2, the circuit arrangement is shown in combination with an electric machine 2a which has a plurality of winding phases 20a which are connected to form delta circuits 24a, 24b. Here, the half bridges 12 of one line U, V, W are each assigned to different delta circuits 24a, 24b.

The winding phases 20, 20a are each supplied with a phase of an alternating current and can comprise a plurality of winding units which are connected in series or in parallel with one another.

The switching elements 10, 11 are embodied as MOSFET transistors in the exemplary embodiments. They are configured here in such a way that the maximum acceptable operating current of the transistors 10, 11 is lower than the maximum operating current of the electric machine 2.

A plurality of half bridges 12 are connected in parallel with one another and form a line U, V, W via which a phase of an alternating current is fed to the electric machine. The black dots next to the switching elements 10, 11 symbolize that the number of half bridges 12 which are connected in parallel can be extended to more than two half bridges 12. The half bridges 12 of one line U, V, W are each assigned to different star circuits 22 or delta circuits. It is particularly preferred to embody the lines U, V, W with two half bridges 12 which are connected in parallel with one another and to operate them with an electric machine 2, 2a which has winding phases 20, 20a which are connected to form two star circuits or delta circuits.

In both the exemplary embodiments, the circuit arrangement is retained in principle. All that changes is the assignment of the connections 13 of the half bridges 12 to the respective winding units 21 or delta circuits 20a.

The lines U, V, W are coupled electrically to a power source 30, wherein, depending on requirements, further control elements can be provided between the power source 30 and circuit arrangement 1 for controlling the supplied current.

The entire phase current or the entire phase voltage is divided by the redundancy of the half bridges into a plurality of phase currents U₁, . . . , Uₙ; V₁, . . . , Vₙ; W₁, . . . , Wₙ and supplied respectively to the winding units 21 and the delta circuits 20a. If a half bridge 12 of a line U, V, W fails, the remaining half bridges 12 of the line U, V, W continue to remain intact, with the result that the electric machine can continue to be operated at least partially.

The circuit arrangement 1 also has a plurality of conductors 14 for conducting the current, said conductors 14 being illustrated only schematically in the figures. Thanks to the reduced phase currents, it is possible to make the cross section of the conductor 14 between the switching elements of the half bridge and the connection 13 of a half bridge 12 and the electric machine 2 smaller than the cross section of a conductor which would be necessary to conduct the maximum operating current of the electric machine 2.

### FURTHER ADVANTAGEOUS EMBODIMENTS

The invention also relates to a drive device having a circuit arrangement and an electric machine according to the following embodiments.

### Embodiment 1

Electric machine of a drive device, in particular for a power steering system of a motor vehicle, having a stator device and a rotor device, and a plurality of winding units with a first and second connection, which connections are arranged on the stator device, wherein a plurality of winding units are electrically coupled by means of the connections to a drive unit in order to generate, by means of a power supply, a magnetic field for driving the rotor device of the electric machine,

characterized in that the electric machine has at least two drive units, operated independently of one another, for driving the rotor device of the electric machine.

### Embodiment 2

Electric machine according to embodiment 1, characterized in that each drive unit has connections for feeding the current, wherein the connections of the drive units are each electrically decoupled from one another.

### Embodiment 3

Electric machine according to one of the preceding embodiments, characterized in that each drive unit has the same number of winding units.

### Embodiment 4

Electric machine according to one of the preceding embodiments, characterized in that the number of winding units per drive unit is unequal.

### Embodiment 5

Electric machine according to one of the preceding embodiments, characterized in that the electric machine has two drive units.

### Embodiment 6

Electric machine according to one of the preceding embodiments, characterized in that the drive units are arranged adjacently to one another.

### Embodiment 7

Electric machine according to one of the above embodiments, characterized in that an electrically insulating means is arranged between the winding units of different drive units.

### Embodiment 8

Electric machine according to one of the preceding embodiments, characterized in that the stator device has a plurality of winding segments, and in that in each case one winding unit is arranged on a winding segment.

### Embodiment 9

Electric machine according to one of the above embodiments, characterized in that the winding units are electrically connected to one another by means of a star circuit or delta circuit.

1. A circuit arrangement for operating an electric machine which has a plurality of lines (U, V, W), each for one phase of an alternating current for operating the electric machine, wherein each line (U, V, W) has a plurality of switching elements which are connected in series and which form a half bridge, wherein the half bridge has a connection between two switching elements, and wherein the circuit arrangement can be coupled electrically to the electric machine via the connections of the half bridge, wherein each line has a plurality of half bridges which are connected electrically in parallel with one another.

2. The circuit arrangement as claimed in claim 1, wherein the electric machine has a plurality of drive units, wherein the half bridges of one line (U, V, W) are each to be assigned to different drive units.

3. The circuit arrangement as claimed in claim 1, wherein the electric machine has a plurality of winding phases which are connected to form star circuits and each form a drive unit, wherein the half bridges of one line (U, V, W) are each to be assigned to different star circuits.

4. The circuit arrangement as claimed in claim 1, wherein the electric machine has a plurality of winding phases which are connected to form delta circuits and each form a drive unit, wherein the half bridges of one line (U, V, W) are each assigned to different delta circuits.

5. The circuit arrangement as claimed in claim 1, wherein the switching elements have transistors, and wherein a maximum acceptable operating current of the transistor is lower than a maximum operating current of the electric machine.

6. The circuit arrangement as claimed in claim 1, wherein the circuit arrangement has conductors for conducting current, wherein a cross section of the conductors between the switching elements of the half bridge and/or the connection of a half bridge and the electric machine is smaller than the cross section of the conductor for conducting the maximum operating current of the electric machine.

7. The circuit arrangement as claimed in claim 1, wherein the conductor has two half bridges which are connected in parallel with one another.

8. A drive device, for a power steering system of a motor vehicle, having a circuit arrangement as claimed in claim 1.

9. The circuit arrangement as claimed in claim 2, wherein the electric machine has a plurality of winding phases which are connected to form star circuits and each form a drive unit, wherein the half bridges of one line (U, V, W) are each to be assigned to different star circuits.
